(19) United States
(12) Patent Application Publication
(10) Pub. No.: US 2023/0358348 A1
(43) Pub. Date: Nov. 9, 2023

(54) PIPE JOINT DEVICE

(71) Applicant: CHEN WEI PRECISION CO., LTD., Taichung City (TW)

(72) Inventor: Chen-Wei LEE, Taichung City (TW)

(73) Assignee: CHEN WEI PRECISION CO., LTD., Taichung City (TW)

(21) Appl. No.: 17/737,630

(22) Filed: May 5, 2022

(51) Int. Cl. F16L 19/02

(52) U.S. Cl. CPC F16L 19/0206; F16L 19/0237

(57) ABSTRACT

A pipe joint device includes a nut defining a threaded hole and including an inward flange that defines a through hole and that has a shoulder surface facing the threaded hole, a tube body having inner and outer end portions, and a stopper detachably sleeved on the tube body. The inner end portion extends through the through hole, has an inner end surface and an outer peripheral surface connected to the inner end surface and formed with an external thread. The stopper has opposite first and second abutment surfaces and an inner surface formed with an internal thread threadedly engaging the external thread. The inner end portion further extends through the stopper, such that the second abutment surface faces and abuts against the annular shoulder and the first abutment surface is disposed not farther away from the outer end portion than the inner end surface.

### FIELD

The disclosure relates to a joint, more particularly to a pipe joint.

### BACKGROUND

As shown in FIGS. 1 to 3, a conventional pipe joint for connection with a pipeline 6 includes a nut 1 and a joint assembly 2. The nut 1 includes a surrounding wall 101 defining a threaded hole 103, and an inward flange wall 102 defining a through hole 104. The joint assembly 2 includes a first joint member 3, a second joint member 4, and a washer 5 clamped between the first joint member 3 and the second joint member 4. The first joint member 3 defines a first inner hole 301 having an internally threaded segment 302. The second joint member 4 includes a large diameter tube portion 401 defining a second inner hole 405, a small diameter tube portion 402 defining a communicating hole 406 having an externally threaded segment 407, a shoulder portion 403 formed between the large diameter tube portion 401 and the small diameter tube portion 402, and an outward flange portion 404 protruding radially and outwardly from the large diameter tube portion 401.

To assemble such conventional pipe joints, it is required to first sleeve the washer 5 on the small diameter tube portion 402 of the second joint member 4. Then, the small diameter tube portion 402 is brought to extend through the through hole 104 of the nut 1, so as to allow the externally threaded segment 407 to threadedly engage the internally threaded segment 302 of the first joint member 3, in such a manner that the washer 5 is clamped between the shoulder portion 403 and an end surface of the first joint member 3 facing the second joint member 4. When the conventional pipe joint is to be connected to the pipeline 6, another leak-proof washer 7 is disposed in the threaded hole 103 of the first nut 1. The first nut 1 is brought to threadedly engage the pipeline 6 such that the leak-proof washer 7 is clamped between the flange portion 404 and an end surface of the pipeline 6 facing the flange portion 404.

However, since the joint assembly 2 of the conventional pipe joint includes the first joint member 3 and the second joint member 4 which are threadedly connected to each other, leaking of the conventional pipe joint can be expected. In order to prevent leakage, the washer 5 is clamped in a junction between the first joint member 3 and the second joint member 4. However, such designs increase the manufacturing cost. In addition, since the second inner hole 405 of the second joint member 4 communicates with the first inner hole 301 of the first joint member 3 through the communicating hole 406 of the second joint member 4 that has a diameter smaller than that of the first inner hole 301 of the first joint member 3 and that of the second inner hole 405 of the second joint member 4, a pressure of the fluid flowing through a flow path from either one of the second inner hole 405 or the inner hole 301 into the communicating hole 406 is increased, which may also lead to leakage between the first joint member 3 and the second joint member 4.

### SUMMARY

Therefore, an object of the disclosure is to provide a pipe joint device capable of alleviating at least one of the drawbacks of the conventional pipe joint.

According to an aspect of the disclosure, a pipe joint device includes a nut, and a joint assembly. The nut includes a surrounding wall surrounding an axis and defining a threaded hole that extends along the axis, and an inward flange wall extending radially and inwardly from one end of the surrounding wall. The inward flange wall surrounds the axis, defines a connecting through hole in spatial communication with the threaded hole, and has an annular shoulder surface facing the threaded hole. The connecting through hole has a diameter smaller than that of the threaded hole. The joint assembly is connected detachably to the nut and includes a joint tube body that surrounds the axis and that defines a joint inner hole extending along the axis, and an annular stopper sleeved detachably on the joint tube body. The joint tube body has an inner end portion that extends through the connecting through hole, and an outer end portion opposite to the inner end portion along the axis. The inner end portion has an inner end surface and an outer peripheral surface that is connected to the inner end surface, and that is formed with an external thread. The external thread of the outer peripheral surface of the inner end portion of the joint tube body is adjacent to the inner end surface. The annular stopper has a first abutment surface, a second abutment surface opposite to the first abutment surface along the axis, and an inner surface connected between the first abutment surface and the second abutment surface. The inner surface is formed with an internal thread threadedly engaging the external thread. The inner end portion further extends through the annular stopper, such that the second abutment surface faces and abuts against the annular shoulder surface of the inward flange wall. The first abutment surface of the annular stopper is disposed not farther away from the outer end portion of the joint tube body than the inner end surface along the axis.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary perspective view of a conventional pipe joint connected to a pipeline;

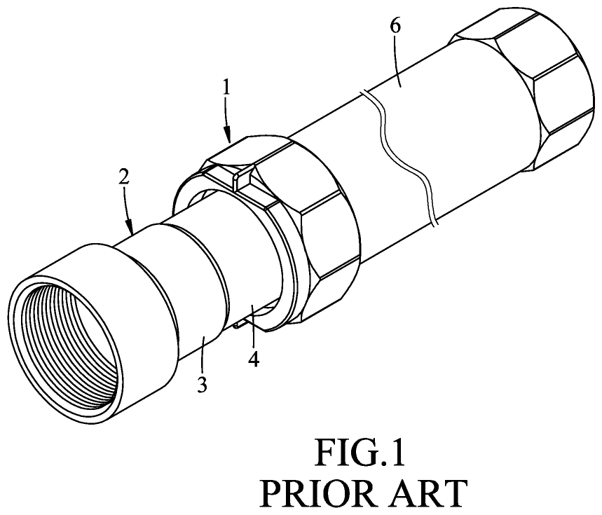

FIG. 2 is a fragmentary exploded perspective view of the conventional pipe joint and the pipeline;

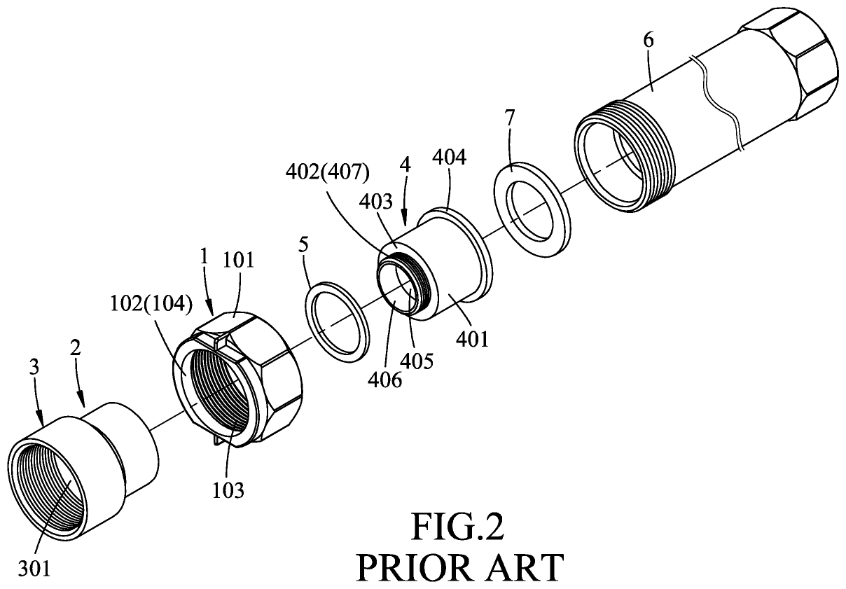

FIG. 3 is a fragmentary schematic sectional view of the conventional pipe joint and the pipeline;

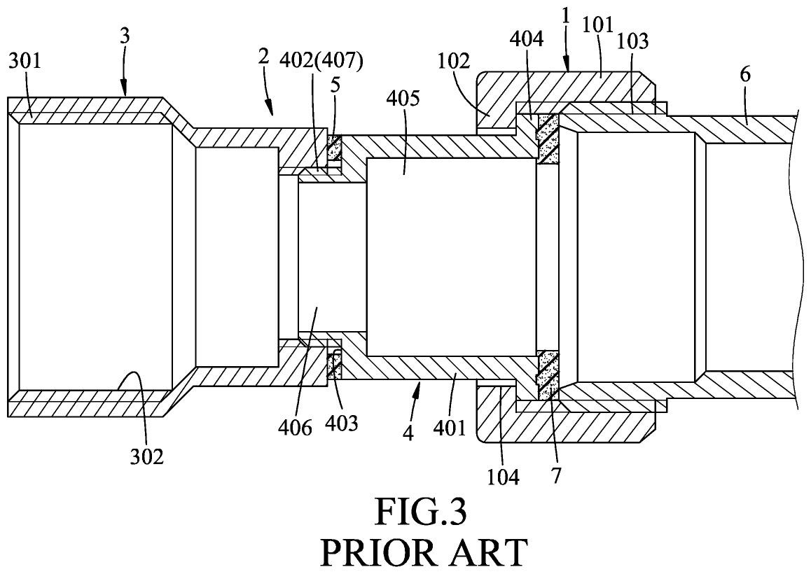

FIG. 4 is a fragmentary perspective view of a pipe joint device according to an embodiment of the present disclosure connected to a pipeline;

FIG. 5 is a fragmentary exploded perspective view of the embodiment and the pipeline;

FIG. 6 is a fragmentary schematic sectional view of the embodiment and the pipeline; and

FIG. 7 is a view similar to FIG. 6, but illustrating a variation of the embodiment.

### DETAILED DESCRIPTION

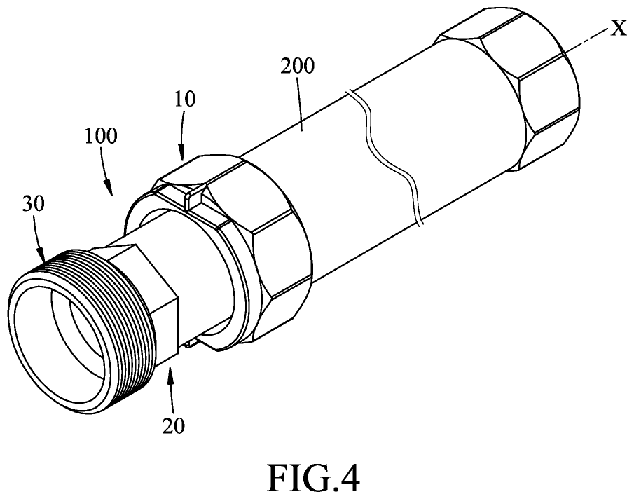

Referring to FIGS. 4 to 6, an embodiment of a pipe joint device 100 of the present disclosure is shown. The pipe joint device 100 includes a nut 10 and a joint assembly 20. In this embodiment, the pipe joint device 100 is adapted to be connected to a pipeline 200.

The nut 10 includes a surrounding wall 11 surrounding an axis (X) and defining a threaded hole 111 extending along the axis (X), and an inward flange wall 12 extending radially and inwardly from one end of the surrounding wall 11.

The inward flange wall 12 surrounds the axis (X), defines a connecting through hole 122 in spatial communication with the threaded hole 111, and has an annular shoulder surface 121 facing the threaded hole 111. A diameter of the connecting through hole 122 is smaller than that of the threaded hole 111.

The joint assembly 20 is detachably connected to the nut 10, and includes a joint tube body 30 that surrounds the axis (X) and that defines a joint inner hole 33, and an annular stopper 40 that is sleeved detachably on the joint tube body 30.

The joint tube body 30 has an inner end portion 31 extending through the connecting through hole 122, and an outer end portion 32 opposite to the inner end portion 31 along the axis (X). The inner end portion 31 has an inner end surface 311, and an outer peripheral surface 312 connected to the inner end surface 311 and formed with an external thread 313.

In this embodiment, the external thread 313 is adjacent to the inner end surface 311 and has a length (L) along the axis (X).

The annular stopper 40 has a first abutment surface 41, a second abutment surface 42 opposite to the first abutment surface 41, and an inner surface 43 connected between the first abutment surface 41 and the second abutment surface 42. The inner surface 43 is formed with an internal thread 431.

In this embodiment, the annular stopper 40 has a thickness (T) along the axis (X) smaller than the length (L) of the external thread (313).

The inner end portion 31 further extends through the annular stopper 40 such that the second abutment surface 42 faces and abuts against the annular shoulder surface 121 of the inward flange wall 12. Note that the first abutment surface 41 of the annular stopper 40 is not farther away from the outer end portion 32 of the joint tube body 30 than the inner end surface along the axis (X). In this embodiment, only a portion of the external thread 313 threadedly engages the internal thread 431, and the first abutment surface 41 of the annular stopper 40 may be flush with the inner end surface 311 of the inner end portion 31 of the joint tube body 30 along the axial direction (X).

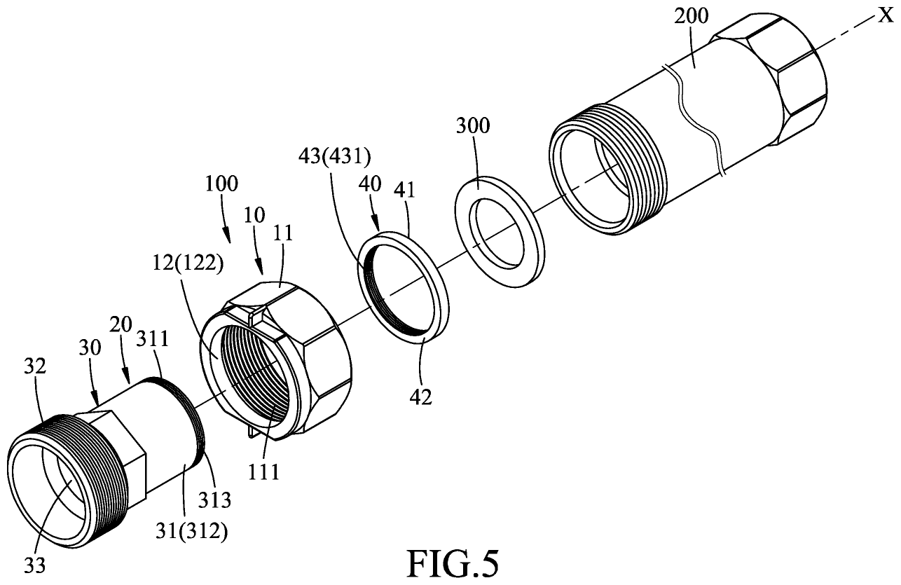

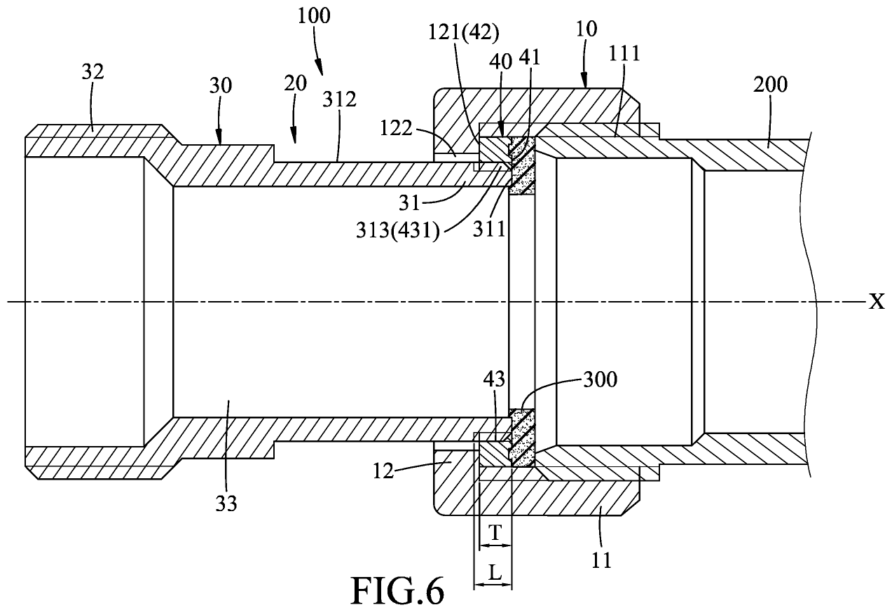

As shown in FIGS. 5 and 6, to assemble the pipe joint device 100, it is required to first bring the inner end portion 31 of the joint tube body 30 to extend through the connecting through hole 122 of the nut 10 and then extend outwardly of the threaded hole 111. Next, the annular stopper 40 is threadedly connected to the outer peripheral surface 312 of the inner end portion 31 through engagement between the internal thread 431 and the external thread 313. Thus, through the structure of the second abutment surface 42 of the annular stopper 40 abutting against the annular shoulder surface 121 of the inward flange wall 12, the joint assembly 20 can be prevented from being removed from the nut 10. In this way, when the pipe joint device 100 is to be connected to the pipeline 200, a leak-proof washer 300 is disposed in the threaded hole 111 of the nut 10. The nut 10 is rotated relative to and moves along the pipeline 200 to be tightened on the pipeline 200 such that the inward flange wall 12 of the nut 10 abutting against the annular stopper 40 is moved toward the pipeline 200. As such, the leak-proof washer 300 is clamped between the first abutment surface 41 of the annular stopper 40 and an end surface of the pipeline 200 that faces the joint tube body 30, and between the inner end surface 311 of the inner end portion 31 and the end surface of the pipeline 200.

As described above, the advantages of the present disclosure can be summarized as follows:

First, since the annular stopper 40 of the joint assembly 20 of the pipe joint device 100 of the present disclosure is sleeved on and threadedly engages the outer peripheral surface 312 of the joint tube body 30, a diameter of the joint inner hole 33 of the joint tube body 30 is not affected after the annular stopper 40 is connected to the joint tube body 30. By virtue of the structure of the joint tube body 30 and the annular stopper 40, the joint assembly 20 of the present disclosure can effectively reduce the possibility of leakage with only one washer 300. Thus, as compared to the conventional pipe joint, a leak-proof washer such as the leak-proof washer 5 described in the background section is not required to be mounted between the joint tube body 30 and the annular stopper 40 for preventing leakage therebetween and the manufacturing cost of the present disclosure can be reduced.

Second, in comparison with the prior art, the annular stopper 40 of the joint assembly 20 of the pipe joint device 100 of the present disclosure that threadedly engages the outer peripheral surface 312 of the joint tube body 30 would not block or affect the fluid flowing through a flow path defined by the pipe joint device 100 and the pipeline 200. As such, smooth flow of the fluid through the joint tube body 30 and the pipeline 200 can be ensured.

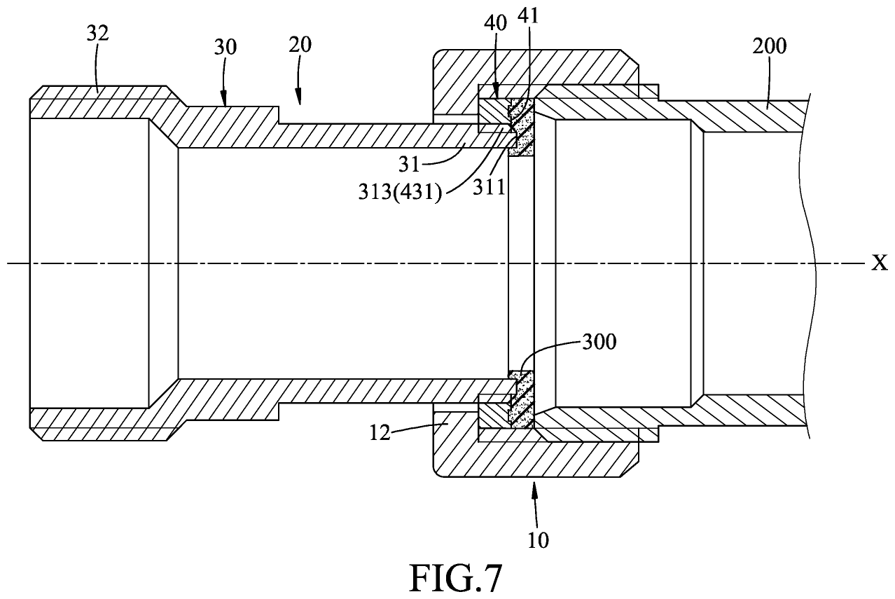

It is worth mentioning that, as shown in FIG. 7, in a variation of the joint assembly 20, the annular stopper 40 can be threadably tightened on the inner end portion 31 of the joint tube body 30 so that the first abutment surface 41 of the annular stopper 40 is disposed closer to the outer end portion 32 of the joint tube body 30 than the inner end surface 311 along the axis (X). Thus, when the nut 10 is rotated to be tightened on the pipeline 200, the inward flange 12 pushes the annular stopper 40 toward the pipeline 200 to tightly clamp the leak-proof washer 300 between the annular stopper 40 and the pipeline 200, and a pressure exerted by the inner end surface 311 of the inner end portion 31 on the leak-proof washer 300 along the axis (X) is greater than that exerted by the inner end surface 311 when it was in the configuration shown in FIG. 6. As a result, the amount of pressure exerted on the leak-proof washer 300 is increased as compared to that when it was in FIG. 6. Even if the end surface of the pipeline 200 that faces the joint tube body 30 is not aligned with the inner end surface 311 of the inner end portion 31 of the joint tube body 30 along the axis (X), the inner end surface 311 of the inner end portion 31 of the joint tube body 30 exerts a pressure on the leak-proof washer 300 in FIG. 7 greater than that exerted in FIG. 6 to thereby provide a relatively good leak-proof effect. As such, it is not necessary to apply a glue for preventing leakage between the internal thread 431 of the annular stopper 40 and the external thread 313 of the inner end portion 31 and a leak-proof effect can be achieved.

In summary, the pipe joint device 100 of the present disclosure is not prone to cause leakage and the number of the leak-proof washer used can be reduced to thereby reduce the manufacturing cost. Further, the fluid flowing through the flow path defined by the joint inner hole 33 of the joint tube body 30 and the pipeline 200 would not be blocked and can thus flowing smoothly. Therefore, the object of the present disclosure is indeed achieved.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pipe joint device comprising:
a nut including a surrounding wall surrounding an axis and defining a threaded hole extending along the axis, and an inward flange wall extending radially and inwardly from one end of said surrounding wall, said inward flange wall surrounding the axis, defining a connecting through hole in spatial communication with said threaded hole, and having an annular shoulder surface facing said threaded hole, said connecting through hole having a diameter that is smaller than that of said threaded hole; and
a joint assembly connected detachably to said nut and including a joint tube body that surrounds the axis and that defines a joint inner hole extending along the axis, and an annular stopper that is sleeved detachably on said joint tube body, said joint tube body having an inner end portion that extends through said connecting through hole, and an outer end portion opposite to said inner end portion along the axis, said inner end portion having an inner end surface, and an outer peripheral surface that is connected to said inner end surface, and that is formed with an external thread, said external thread of said outer peripheral surface of said inner end portion of said joint tube body being adjacent to said inner end surface, said annular stopper having a first abutment surface, a second abutment surface opposite to said first abutment surface along the axis, and an inner surface connected between said first abutment surface and said second abutment surface, said inner surface being formed with an internal thread threadedly engaging said external thread,
wherein, said inner end portion further extends through said annular stopper, such that said second abutment surface faces and abuts against said annular shoulder surface of said inward flange wall, and said first abutment surface of said annular stopper is disposed not farther away from said outer end portion of said joint tube body than said inner end surface along the axis.

2. The pipe joint device as claimed in claim 1, wherein said external thread of said outer peripheral surface of said joint tube body has a length along the axis, and said annular stopper has a thickness along the axis that is smaller than the length of said external thread.
